(19) United States
(12) Patent Application Publication
(10) Pub. No.: US 2026/0369013 A1
(43) Pub. Date: Nov. 19, 2026

(54) INFORMATION PROCESSING SYSTEM, INFORMATION PROCESSING DEVICE, CONVERSION DEVICE, INFORMATION PROCESSING METHOD, AND COMPUTER PROGRAM

(71) Applicant: Sony Interactive Entertainment Inc., Tokyo (JP)

(72) Inventors: Yasunori Matsui, Tokyo (JP); Kiko Sasaki, Tokyo (JP); Ryota Murasugi, Tokyo (JP)

(73) Assignee: Sony Interactive Entertainment Inc., Tokyo (JP)

(21) Appl. No.: 19/143,864

(22) PCT Filed: Jan. 16, 2023
(86) PCT No.: PCT/JP2023/001012

§ 371 Date: Jun. 26, 2025

(51) Int. Cl. G06T 19/00

(52) U.S. Cl. CPC G06T 19/00; G06T 2219/024

(57) ABSTRACT

A metaverse system 10 includes a metaverse A server 12 and a metaverse B server 16. The metaverse A server 12 provides an image of a metaverse A to a first user (for example, a user terminal 14) utilizing the metaverse A. The metaverse B server 16 provides an image of a metaverse B to a second user (for example, a user terminal 18) utilizing the metaverse B. In a case where the metaverse B server 16 receives a request for participation in the metaverse B by the first user, which has been transmitted from the metaverse A server 12, the metaverse B server 16 places a simplified avatar corresponding to the first user in the metaverse B and provides the image of the metaverse B to the first user.

### TECHNICAL FIELD

The present invention relates to a data processing technology, in particular, to an information processing system, an information processing device, a conversion device, an information processing method, and a computer program.

### BACKGROUND ART

A metaverse, which is a three-dimensional virtual space service constructed within computers, is beginning to gain popularity.

For example, users make their own avatars perform actions within the metaverse to interact with other users or participate in events held within the metaverse.

### SUMMARY

### Technical Problem

Currently, a plurality of metaverses are operated independently of each other. The inventors of the present invention have considered that linking a plurality of metaverses is effective to enhance the interest in the metaverse. It is an object of the present invention to provide a technology for suitably linking a plurality of metaverses.

### Solution to Problem

In order to solve the above-mentioned problem, an information processing system of a certain aspect of the present invention includes a first device configured to provide an image of a first metaverse to a first user utilizing the first metaverse, and a second device configured to provide an image of a second metaverse to a second user utilizing the second metaverse. In a case where the second device receives a request for participation in the second metaverse by the first user, which has been transmitted from the first device, the second device places a simplified avatar corresponding to the first user in the second metaverse and provides the image of the second metaverse to the first user.

Another aspect of the present invention is an information processing device. This device is a device configured to provide, to a user of a predetermined metaverse, an image of the metaverse, the information processing device including a reception unit configured to receive a request for participation in the predetermined metaverse by a user of a different metaverse from the predetermined metaverse, a placement unit configured to place, in the predetermined metaverse, a simplified avatar corresponding to the user of the different metaverse, and a provision unit configured to provide the image of the predetermined metaverse to the user of the different metaverse.

Still another aspect of the present invention is a conversion device. This device is a conversion device configured to communicate with a first device configured to provide an image of a first metaverse to a first user utilizing the first metaverse, and with a second device configured to provide an image of a second metaverse to a second user utilizing the second metaverse, in which in a case where the second device receives a request for participation in the second metaverse by the first user, which has been transmitted from the first device, the second device places a simplified avatar corresponding to the first user in the second metaverse and provides the image of the second metaverse to the first user, and the conversion device includes a retention unit configured to retain a correspondence relation between an avatar operation in the first metaverse and an avatar operation in the second metaverse, and a conversion unit configured to receive an operation that includes an operation input by the first user on the simplified avatar and an avatar operation in the first metaverse, and to transmit information indicating an avatar operation in the second metaverse corresponding to the avatar operation in the first metaverse to the second device.

Yet another aspect of the present invention is an information processing method. This method includes, by a computer configured to provide, to a user of a predetermined metaverse, an image of the metaverse, a step of receiving a request for participation in the predetermined metaverse by a user of a different metaverse from the predetermined metaverse, a step of placing, in the predetermined metaverse, a simplified avatar corresponding to the user of the different metaverse, and a step of providing the image of the predetermined metaverse to the user of the different metaverse.

Note that any combination of the above components as well as modes obtained by converting the expressions of the present invention between computer programs, recording media having stored therein computer programs, or the like are also effective as aspects of the present invention.

### Advantageous Effects of Invention

According to the present invention, it is possible to suitably link the plurality of metaverses.

### BRIEF DESCRIPTION OF DRAWINGS

FIG. 1 is a diagram illustrating a configuration of a metaverse system of a first embodiment.

FIG. 2 is a block diagram illustrating main functional blocks of a metaverse A server.

FIG. 3 is a block diagram illustrating main functional blocks of a metaverse B server.

FIG. 4 is a diagram illustrating an operation of the metaverse system of the first embodiment.

FIG. 5 is a diagram illustrating an example of a metaverse image.

FIG. 6 is a diagram illustrating a modified example of the metaverse image.

FIG. 7 is a diagram illustrating a configuration of a metaverse system of a second embodiment.

FIG. 8 is a block diagram illustrating main functional blocks of a conversion server.

FIG. 9 is a diagram illustrating an operation of the metaverse system of the second embodiment.

### DESCRIPTION OF EMBODIMENTS

The overview of embodiments is described. In the embodiments, the metaverse refers to a three-dimensional virtual space (also called a cyberspace) and services related thereto. Users participating in the metaverse make avatars, which are characters representing themselves, perform actions within the metaverse to interact with other users or participate in events held within the metaverse. In the embodiments, a technology for suitably linking a plurality of metaverses is proposed.

As one method for linking a plurality of metaverses, it is conceivable to distribute video of an event (for example, a virtual concert) held in a certain metaverse to other metaverses, thereby displaying the video of the event in question in each metaverse in a distributed manner. In this case, a density of event participants (such as concert audience members) is constrained by a capacity of each metaverse. In general, the density of participants does not become very high, potentially resulting in a lack of excitement of the event.

As another method for linking a plurality of metaverses, it is conceivable to hold an event (for example, a virtual concert) in a certain metaverse independently, and to accept participation of users (avatars) of other metaverses in that event. In this case, it is necessary that the metaverse in which the event is held retain avatar assets (for example, data regarding shapes and decorations) from other metaverses and have infrastructure capable of accommodating all participants for the event. Therefore, linking using this method is not easy either.

In the following, a first metaverse is referred to as a “metaverse A,” and a second metaverse different from the first metaverse is referred to as a “metaverse B.” For example, the metaverse A is a metaverse for an online game A, and the metaverse B is a metaverse for an online game B. In metaverse systems of the embodiments, the metaverse A is linked to the metaverse B, specifically, participation of users (avatars) of the metaverse A in events held in the metaverse B is accepted. However, avatars of users of the metaverse A participating in events in the metaverse B are restricted to simplified avatars (hereinafter referred to as a “simple avatars”). The simple avatar is an avatar with a smaller amount of information than normal avatars in the metaverse A and the metaverse B, and is an avatar with a simplified appearance shape and color, for example.

Specifically, in a case where a device configured to provide the metaverse B receives a request for participation in the metaverse B by a user of the metaverse A, the device places a simple avatar corresponding to the user of the metaverse A in the metaverse B. The device configured to provide the metaverse B provides images of the metaverse B having placed therein the simple avatar to the user of the metaverse A who has requested participation in the metaverse B. With this, it is possible to increase the density of participants at events held in the metaverse B, thereby promoting the excitement of the events. On the other hand, it is possible to prevent an increase in the processing load on the device configured to provide the metaverse B. Furthermore, it is also possible to promote linking between a plurality of metaverses, thereby improving appeal and ability to attract users of the metaverse.

### First Embodiment

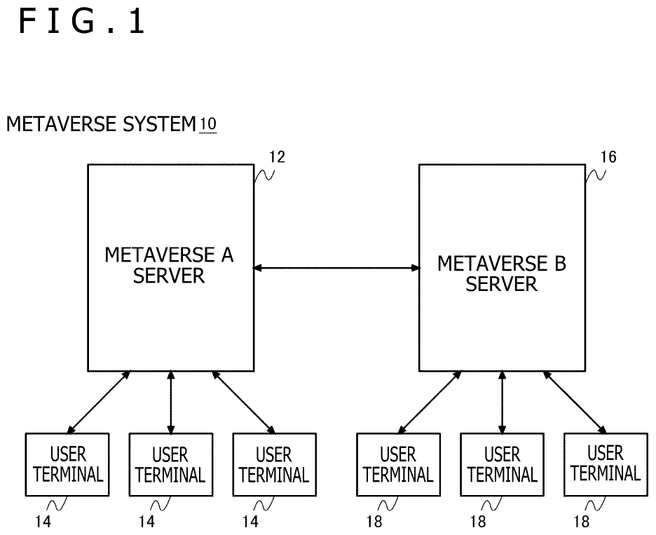

FIG. 1 illustrates a configuration of a metaverse system 10 of a first embodiment. The metaverse system 10 is an information processing system configured to provide metaverse services to a plurality of users. The metaverse system 10 includes a metaverse A server 12, which serves as a first device, and a metaverse B server 16, which serves as a second device.

The metaverse A server 12 is an information processing device configured to manage the metaverse A and users thereof. The metaverse A server 12 provides images of the metaverse A to a first user registered with the metaverse A and utilizing the metaverse A (hereinafter referred to as the “metaverse A user”). The metaverse B server 16 is an information processing device configured to manage the metaverse B and users thereof. The metaverse B server 16 provides images of the metaverse B to a second user registered with the metaverse B and utilizing the metaverse B (hereinafter referred to as the “metaverse B user”). The image of the metaverse includes at least video of the metaverse. Furthermore, the image of the metaverse may be a generally-called virtual reality image or an augmented reality image.

The metaverse A server 12 and the metaverse B server 16 may each include a plurality of devices. For example, the metaverse A server 12 and the metaverse B server 16 may each be achieved through cooperation between one or more communication devices, image generation devices, database devices, and the like.

A plurality of user terminals 14 are information terminals to be operated by a plurality of metaverse A users. A plurality of user terminals 18 are information terminals to be operated by a plurality of metaverse B users. The user terminal 14 and the user terminal 18 may be PCs, smartphones, tablet devices, game consoles, head-mounted displays, or the like. The user terminal 14 and the user terminal 18 may include controllers (operating devices). Each device of FIG. 1 is connected via a communication network including a local area network (LAN), a wide area network (WAN), the Internet, or the like.

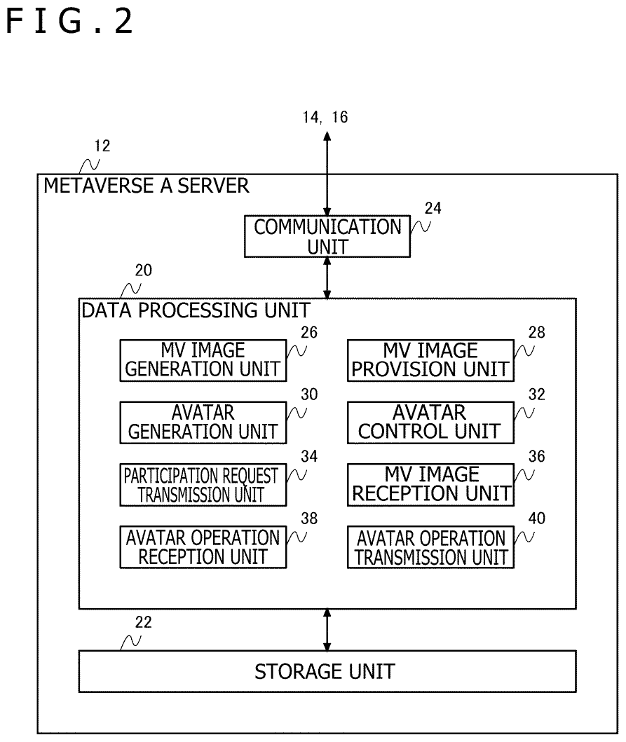

FIG. 2 is a block diagram illustrating main functional blocks of the metaverse A server 12. Each block illustrated in the block diagrams herein can be achieved by elements such as computer processors, central processing units (CPUs), or memory, electronic circuits, or mechanical devices in terms of hardware, or by computer programs loaded into memory or the like in terms of software. Here, functional blocks achieved through cooperation therebetween are illustrated. Thus, it is to be understood by those skilled in the art that these functional blocks can be achieved in various forms through combinations of hardware and software.

The metaverse A server 12 includes a data processing unit 20, a storage unit 22, and a communication unit 24. The data processing unit 20 executes various types of data processing related to the metaverse A. The storage unit 22 stores data to be referenced or updated by the data processing unit 20. The communication unit 24 communicates with external devices in accordance with a predetermined communication protocol. The data processing unit 20 sends and receives data to and from the user terminal 14 and the metaverse B server 16 via the communication unit 24.

The storage unit 22 stores information associated with a plurality of users belonging to the metaverse A (in other words, registered with the metaverse A). For example, the storage unit 22 stores data regarding avatars in the metaverse A corresponding to the respective plurality of users, typically, data regarding avatars defined by the respective users. The avatar data includes data associated with the appearance (for example, a shape and color) of the avatar of each user.

The data processing unit 20 includes an MV image generation unit 26, an MV image provision unit 28, an avatar generation unit 30, an avatar control unit 32, a participation request transmission unit 34, an MV image reception unit 36, an avatar operation reception unit 38, and an avatar operation transmission unit 40.

The functions of the plurality of functional blocks of the data processing unit 20 may be implemented by a computer program (hereinafter referred to as a “metaverse management application”). The metaverse management application may be stored in a computer-readable non-transitory recording medium and installed into the storage of the metaverse A server 12 through that recording medium. Alternatively, the metaverse management application may be downloaded via a communication network and installed into the storage of the metaverse A server 12. The processor (such as a CPU) of the metaverse A server 12 may read out the metaverse management application into the main memory and execute the metaverse management application, thereby providing the functions of the above-mentioned plurality of functional blocks.

The MV image generation unit 26 generates images of the metaverse A. The MV image provision unit 28 transmits images of the metaverse A generated by the MV image generation unit 26 to the user terminal 14, which is an information terminal of the metaverse A user, for display.

The avatar generation unit 30 generates an avatar of each user who has logged into the metaverse A, on the basis of avatar data regarding each user, which is stored in the storage unit 22, and places the avatar of each user in the metaverse A.

The avatar control unit 32 acquires avatar operation information indicating operations by the metaverse A user on the avatar, which has been transmitted from the user terminal 14. On the basis of the avatar operation information, the avatar control unit 32 makes the avatar corresponding to the metaverse A user, from which the avatar operation information has been transmitted, perform actions. Examples of avatar actions may include jumping, dashing movements, waving hands, and clapping.

The participation request transmission unit 34 transmits, on the basis of operations received from the metaverse A user (user terminal 14), data requesting participation in the metaverse B by the metaverse A user to the metaverse B server 16. The participation request transmission unit 34 stores information indicating the metaverse A user who has temporarily participated in the metaverse B (hereinafter also referred to as the “metaverse B temporary participating user”) in the storage unit 22.

The MV image reception unit 36 receives images of the metaverse B for the metaverse B temporary participating user, which have been transmitted from the metaverse B server 16. The MV image provision unit 28 transmits images of the metaverse B for the metaverse B temporary participating user, which have been received by the MV image reception unit 36, to the user terminal 14 of the metaverse B temporary participating user for display.

The avatar operation reception unit 38 receives information regarding operations by the metaverse A user on his/her own avatar (normal avatar) in the metaverse A, which has been transmitted from the user terminal 14. Furthermore, the avatar operation reception unit 38 receives information regarding operations by the metaverse B temporary participating user on his/her own simple avatar in the metaverse B, which has been transmitted from the user terminal 14 of the metaverse B temporary participating user.

The avatar operation transmission unit 40 transmits information regarding operations by the metaverse B temporary participating user on the simple avatar in the metaverse B, which has been received by the avatar operation reception unit 38, to the metaverse B server 16. In the embodiment, the information regarding operations on the simple avatar, which is transmitted by the avatar operation transmission unit 40, is information indicating the action content of the simple avatar and may include, for example, jumping, dashing movements, waving hands, and clapping.

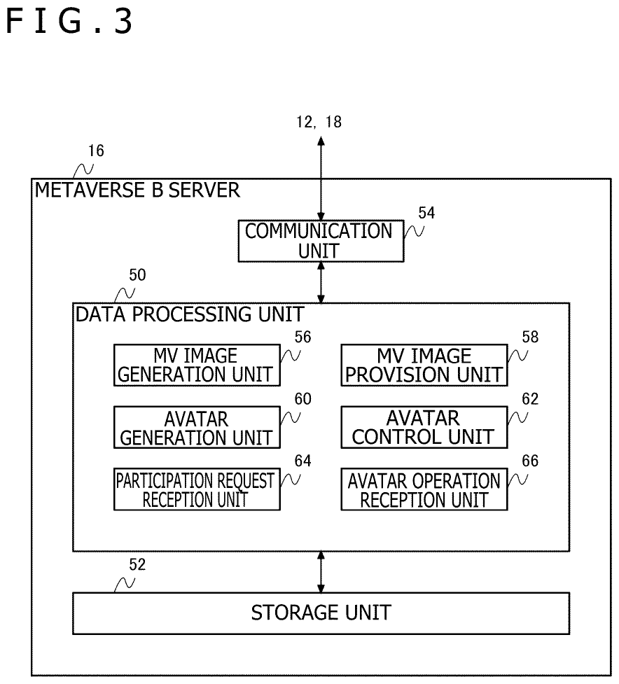

FIG. 3 is a block diagram illustrating the main functional blocks of the metaverse B server 16. The metaverse B server 16 includes a data processing unit 50, a storage unit 52, and a communication unit 54. The data processing unit 50 executes various types of data processing related to the metaverse B. The storage unit 52 stores data to be referenced or updated by the data processing unit 50. The communication unit 54 communicates with external devices in accordance with a predetermined communication protocol. The data processing unit 50 sends and receives data to and from the user terminal 18 and the metaverse A server 12 via the communication unit 54.

The storage unit 52 stores information associated with a plurality of users belonging to the metaverse B (in other words, registered with the metaverse B). For example, the storage unit 52 stores data regarding avatars in the metaverse B corresponding to the respective plurality of users, typically, data regarding avatars defined by the respective users.

The storage unit 52 stores data associated with simple avatars to be assigned to users of other metaverses (for example, metaverse A users). The simple avatar contains a smaller amount of information than the avatar corresponding to the metaverse A user set in the metaverse A. Furthermore, the simple avatar contains a smaller amount of information than the avatar corresponding to the metaverse B user set in the metaverse B. The amount of information being small includes the data size being small.

For example, the simple avatar may be an avatar whose appearance (such as a shape or color) has been simplified such that the amount of information is reduced. The simple avatar may be expressed as a silhouette or a stick figure. Furthermore, at least one of the normal avatar and the simple avatar may have added thereto a mark indicating that the one avatar is different from the other avatar for differentiation from the other avatar. The mark may be a special color or a special effect such as light emission.

The data processing unit 50 includes an MV image generation unit 56, an MV image provision unit 58, an avatar generation unit 60, an avatar control unit 62, a participation request reception unit 64, and an avatar operation reception unit 66.

The functions of the plurality of functional blocks of the data processing unit 50 may be implemented by a metaverse management application. The metaverse management application may be stored in a computer-readable non-transitory recording medium and installed into the storage of the metaverse B server 16 through that recording medium. Alternatively, the metaverse management application may be downloaded via a communication network and installed into the storage of the metaverse B server 16. The processor (such as CPU) of the metaverse B server 16 may read out the metaverse management application into the main memory and execute the metaverse management application, thereby providing the functions of the above-mentioned plurality of functional blocks.

The MV image generation unit 56 generates images of the metaverse B. The MV image provision unit 58 transmits images of the metaverse B generated by the MV image generation unit 56 to the user terminal 18, which is an information terminal of the metaverse B user, for display.

The avatar generation unit 60 generates an avatar of each user who has logged into the metaverse B, on the basis of avatar data regarding each user, which is stored in the storage unit 52, and places the avatar of each user in the metaverse B.

The avatar control unit 62 acquires avatar operation information indicating operations by the metaverse B user on the avatar, which has been transmitted from the user terminal 18. On the basis of the avatar operation information, the avatar control unit 62 makes the avatar (normal avatar) corresponding to the metaverse B user, from which the avatar operation information has been transmitted, perform actions. Examples of avatar actions may include jumping, dashing movements, waving hands, and clapping.

The participation request reception unit 64 receives data requesting participation in the metaverse B by the metaverse A user (metaverse B temporary participating user), which has been transmitted from the metaverse A server 12. In a case where a request for participation in the metaverse B by the metaverse A user is received, the avatar generation unit 60 places the simple avatar corresponding to the metaverse A user (metaverse B temporary participating user) in the metaverse B.

The avatar operation reception unit 66 receives information regarding operations input by the metaverse A user (metaverse B temporary participating user) on the simple avatar, which has been transmitted from the metaverse A server 12. The avatar control unit 62 makes, in response to operations input by the metaverse A user (metaverse B temporary participating user) on the simple avatar, the simple avatar corresponding to the metaverse A user (metaverse B temporary participating user) perform actions within the metaverse B.

The actions of the simple avatar corresponding to the metaverse A user (metaverse B temporary participating user) within the metaverse B are restricted to simplified actions defined in advance. The simplified action can be called an action simpler than the actions of the normal avatar and can also be called a non-complex action or a basic action. Examples of normal avatar actions within the metaverse A may include jumping, dashing movements, waving hands, clapping, dancing, and speaking. Furthermore, normal avatar actions within the metaverse B may include jumping, dashing movements, waving hands, clapping, dancing, and emitting light. In this case, the actions of the simple avatar may be restricted to jumping, dashing movements, waving hands, and clapping.

The operation of the metaverse system 10 configured as described above is described.

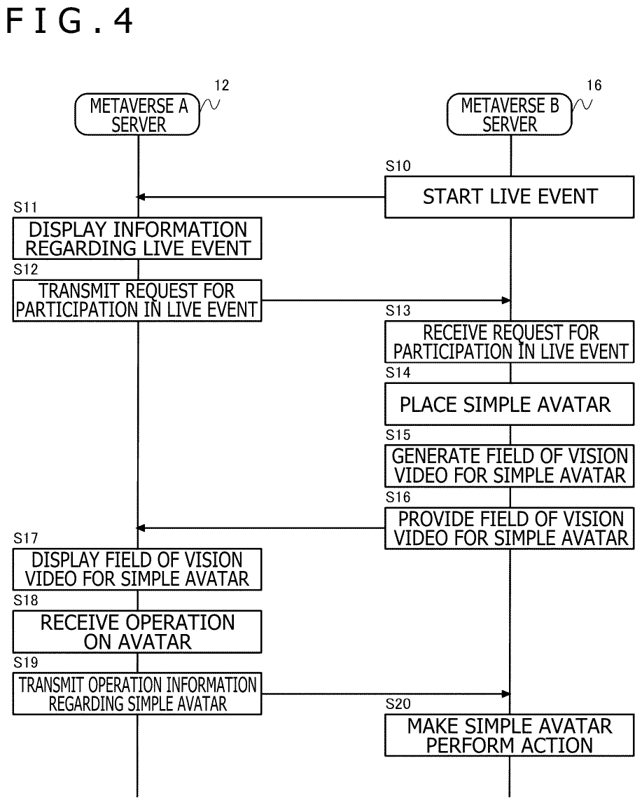

FIG. 4 illustrates the operation of the metaverse system 10 of the first embodiment. The metaverse B server 16 starts a predetermined live event (for example, a virtual concert) in which a plurality of users can participate in the metaverse B (S10). The MV image generation unit 56 of the metaverse B server 16 starts generating video of the metaverse B in which the live event appears. The metaverse B server 16 transmits information associated with the ongoing live event to the metaverse A server 12.

The MV image generation unit 26 of the metaverse A server 12 places the information associated with the live event being held in the metaverse B (for example, live event guide text or thumbnails) within the metaverse A (S11). The user terminal 14 transmits, in response to operations by the metaverse A user, a request for participation in the live event being held in the metaverse B to the metaverse A server 12. The participation request transmission unit 34 of the metaverse A server 12 transmits data requesting participation of the metaverse A user in question in the live event being held in the metaverse B to the metaverse B server 16 (S12). The participation request transmission unit 34 stores information indicating that the metaverse A user in question is a metaverse B temporary participating user in the storage unit 22.

The participation request reception unit 64 of the metaverse B server 16 receives the request from the metaverse A user for participation in the live event being held in the metaverse B, which has been transmitted from the metaverse A server 12 (S13). The avatar generation unit 60 of the metaverse B server 16 places the simple avatar corresponding to the metaverse A user (metaverse B temporary participating user) participating in the live event at the venue of the live event within the metaverse B (S14).

The avatar control unit 62 of the metaverse B server 16 manages the position and line of sight direction of the simple avatar corresponding to the metaverse B temporary participating user in the metaverse B, and passes those pieces of information to the MV image generation unit 56. The MV image generation unit 56 generates video of the metaverse B as viewed from the perspective of the simple avatar (hereinafter also referred to as a “field of vision video”) (S15). In the field of vision video for the simple avatar, for example, scenes of the live event (such as behaviors of performers) visible from the position of the simple avatar appear. The MV image provision unit 58 of the metaverse B server 16 transmits the field of vision video for the simple avatar generated in S15 to the metaverse A server 12 (S16).

The MV image provision unit 28 of the metaverse A server 12 transmits the field of vision video for the simple avatar in which scenes of the live event in the metaverse B appear, which has been transmitted from the metaverse B server 16, to the user terminal 14 of the metaverse B temporary participating user (S17). The user terminal 14 of the metaverse B temporary participating user makes a display unit, which is not illustrated, display the field of vision video for the simple avatar.

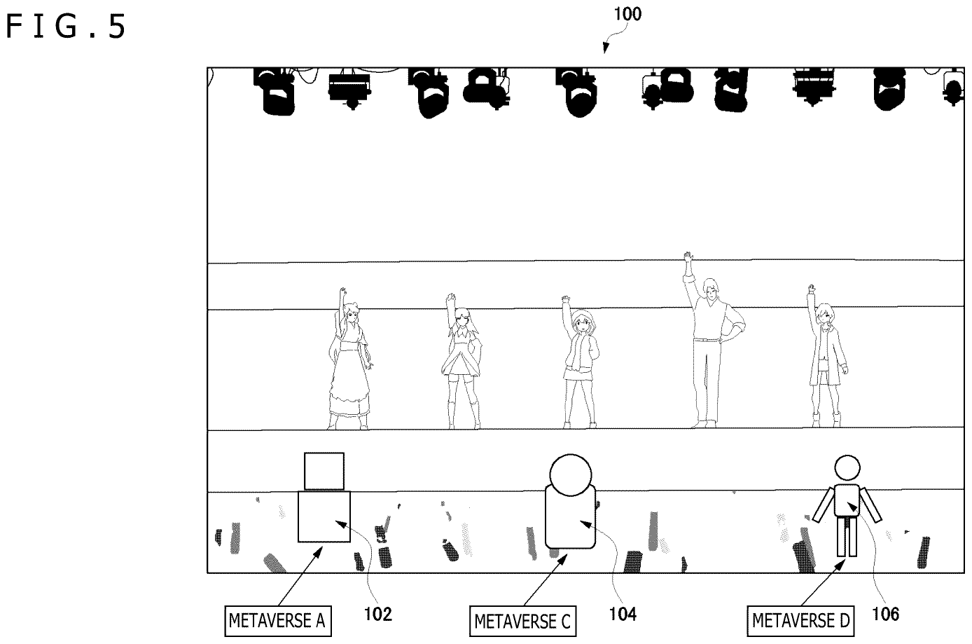

FIG. 5 illustrates an example of a metaverse image. A metaverse image 100 of FIG. 5 represents field of vision video for the simple avatar corresponding to the metaverse B temporary participating user. In the metaverse image 100, scenes on the stage of a live event being held in the metaverse B appear. Furthermore, in the metaverse image 100, as audience members at the live event, normal avatars corresponding to users of the metaverse B as well as a simple avatar 102, a simple avatar 104, and a simple avatar 106 appear. The simple avatar 102 is an avatar corresponding to a user participating from the metaverse A (a user other than the user provided with the metaverse image 100). The simple avatar 104 is an avatar corresponding to a user participating from a metaverse C. The simple avatar 106 is an avatar corresponding to a user participating from a metaverse D.

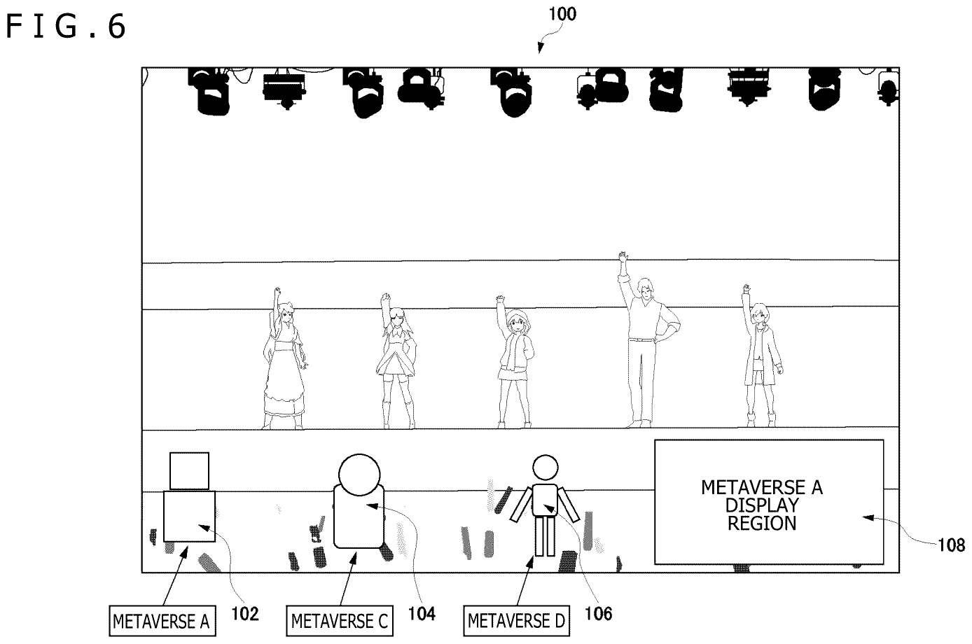

FIG. 6 illustrates a modified example of the metaverse image. The metaverse image 100 of FIG. 6 includes a metaverse A display region 108 in addition to the content of the metaverse image 100 of FIG. 5. The MV image generation unit 26 of the metaverse A server 12 may generate the metaverse image 100 including field of vision video for the simple avatar corresponding to the metaverse B temporary participating user, which has been provided from the metaverse B server, and video of the metaverse A, and may make the user terminal 14 of the metaverse B temporary participating user display the metaverse image 100. The video of the metaverse A displayed in the metaverse A display region 108 may include, for example, field of vision video for the avatar (normal avatar) corresponding to the metaverse B temporary participating user in the metaverse A. As illustrated in FIG. 6, the MV image generation unit 26 of the metaverse A server 12 may generate the metaverse image 100 including both video of the metaverse A and video of the metaverse B, by using picture-in-picture techniques.

The avatar operation reception unit 38 of the metaverse A server 12 receives information regarding an operation on the simple avatar in the metaverse B, which has been transmitted from the user terminal 14 of the metaverse B temporary participating user (S18). The avatar operation transmission unit 40 of the metaverse A server 12 transmits the information regarding an operation on the simple avatar, which has been received in S18, to the metaverse B server 16 (S19). The operation information in S18 and S19 may include information specifying types of actions that the normal avatar in the metaverse A can perform (for example, jumping, dashing movements, waving hands, clapping, dancing, and speaking).

The avatar operation reception unit 66 of the metaverse B server 16 receives the information regarding an operation on the simple avatar of the metaverse B temporary participating user, which has been transmitted from the metaverse A server 12. The avatar control unit 32 of the metaverse B server 16 makes, on the basis of the received operation information, the simple avatar of the metaverse B temporary participating user perform an action at, for example, the venue of the live event within the metaverse B (S20). In a case where the action of the simple avatar specified by the received operation information is included in the restricted simplified actions, the avatar control unit 32 applies the action specified by the operation information to the simple avatar. On the other hand, in a case where the action of the simple avatar specified by the received operation information is not included in the restricted simplified actions, the avatar control unit 32 does not apply the action specified by the operation information to the simple avatar and cancels the action of the simple avatar based on the operation information.

In the metaverse system 10 of the first embodiment, images of the metaverse B (for example, video of a live event) are provided to the metaverse A user, thereby providing a high degree of interest to the user through linking of a plurality of metaverses. Further, the avatar of the metaverse A user is allowed to participate in the live event being held in the metaverse B, thereby enabling the metaverse A user to have a strong sense of participation in the metaverse B. Furthermore, the density of audience members at the live event can be increased, thereby enhancing the excitement of the live event. Furthermore, with the avatar of the metaverse A user to be placed in the metaverse B being configured as a simple avatar, it is possible to reduce the processing load on the metaverse B server 16, thereby avoiding, for example, the shortage of hardware resources of the metaverse B server 16.

In the above, the present invention has been described on the basis of the first embodiment. This embodiment is illustrative, and it is to be understood by those skilled in the art that various modifications of combinations of each component and each processing process are possible, and that such modifications also fall within the scope of the present invention.

A first modified example related to the first embodiment is described. The metaverse B server 16 may display, in the metaverse B, the simple avatar corresponding to the metaverse A user (metaverse B temporary participating user) in a mode indicating that the simple avatar corresponds to the metaverse A user. For example, the avatar generation unit 60 of the metaverse B server 16 may place, in the metaverse B, a simple avatar corresponding to the metaverse A user (metaverse B temporary participating user) and having an appearance indicating that the simple avatar corresponds to the metaverse A user. The appearance indicating that the simple avatar corresponds to the metaverse A user may include having added information indicating that the simple avatar corresponds to the metaverse A user, or having a shape or color only assigned to the metaverse A user (different from those for users of other metaverses).

Furthermore, the metaverse B server 16 may display, in the metaverse B, each of a plurality of simple avatars corresponding to users of a plurality of other metaverses in a mode indicating to which metaverse each user belongs. For example, as illustrated in FIG. 5 and FIG. 6, the avatar generation unit 60 of the metaverse B server 16 may assign, to each user temporarily participating in the metaverse B from each respective metaverse, a simple avatar assigned to each metaverse in advance and having a shape different across the metaverses. This mode allows the user of the metaverse B (for example, a performer at a live event) to recognize to which metaverse the user temporarily participating in the metaverse B (for example, an audience member at the live event) belong, and to perform actions (for example, calls from the performer) corresponding to such recognition.

A second modified example related to the first embodiment is described. The metaverse A server 12 may hide, while a certain metaverse A user is participating in the metaverse B, an avatar (normal avatar) corresponding to the metaverse A user in question in the metaverse A. For example, the avatar control unit 32 of the metaverse A server 12 may delete, while a certain metaverse A user is participating in the metaverse B, an avatar (normal avatar) corresponding to the metaverse A user in question from the metaverse A.

A third modified example related to the first embodiment is described. The metaverse A server 12 may make, while a certain metaverse A user is participating in the metaverse B, an avatar (normal avatar) corresponding to the metaverse A user in question in the metaverse A perform the same actions as those of a simple avatar corresponding to the metaverse A user in question in the metaverse B. As described in the first embodiment, in a case where information regarding operations on the simple metaverse in the metaverse B is received from the metaverse B temporary participating user, the avatar operation transmission unit 40 of the metaverse A server 12 transmits the information regarding operations on the simple metaverse to the metaverse B server 16. In parallel to this, the avatar control unit 32 of the metaverse A server 12 may make the normal avatar corresponding to the metaverse B temporary participating user in the metaverse A perform actions specified by the information regarding operations on the simple metaverse.

A fourth modified example related to the first embodiment is described. The metaverse A server 12 may display, while a certain metaverse A user is participating in the metaverse B, an avatar (normal avatar) corresponding to the metaverse A user in question in the metaverse A in a mode indicating that the metaverse A user is currently participating in the metaverse B. For example, the avatar control unit 32 of the metaverse A server 12 may display the normal avatar corresponding to the metaverse A user in question in the metaverse A with added information indicating that the metaverse A user is currently participating in the metaverse B.

A fifth modified example related to the first embodiment is described. In the above-mentioned embodiment, the configuration in which users of the metaverse A temporarily participate in the metaverse B has been described; however, a configuration in which users of the metaverse B can temporarily participate in the metaverse A may be employed. In this case, the metaverse A server 12 may include the participation request reception unit 64 and the avatar operation reception unit 66 illustrated in FIG. 3, in addition to the functional blocks illustrated in FIG. 2. The metaverse B server 16 may include the participation request transmission unit 34, the MV image reception unit 36, and the avatar operation transmission unit 40 illustrated in FIG. 2, in addition to the functional blocks illustrated in FIG. 3.

A sixth modified example related to the first embodiment is described. The user terminal 14 (for example, a controller) of the metaverse A user temporarily participating in the metaverse B may directly transmit information regarding operations on the simple avatar (for example, information specifying types of actions of the simple avatar) to the metaverse B server 16 without intermediation of the metaverse A server 12.

### Second Embodiment

Regarding a second embodiment, the points different from the first embodiment are mainly described, and the description of common points is omitted as appropriate. The features of the second embodiment can be optionally combined with the features of the first embodiment or the modified examples. Among the components of the second embodiment, components that are the same as or correspond to the components of the first embodiment are appropriately denoted by the same reference signs and described.

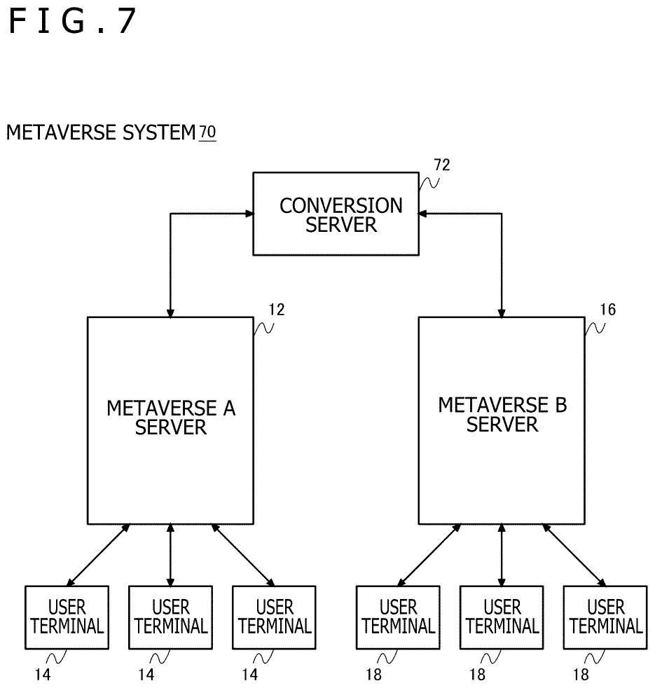

FIG. 7 illustrates the configuration of a metaverse system 70 of the second embodiment. The metaverse system 70 includes a conversion server 72 in addition to the devices forming the metaverse system 10 of the first embodiment. The conversion server 72 is connected to the metaverse A server 12 and the metaverse B server 16 via a communication network. The metaverse A server 12 is linked to the metaverse B server 16 via the conversion server 72. The metaverse A server 12 and the metaverse B server 16 have functional blocks similar to those of the first embodiment.

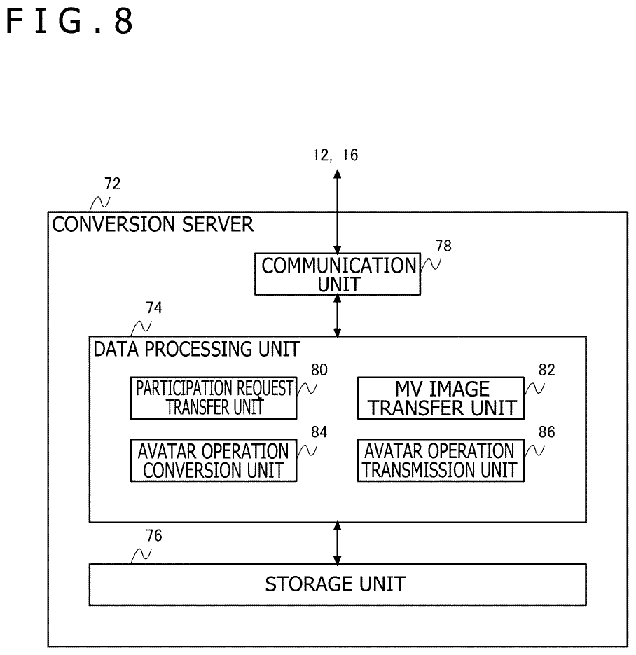

The conversion server 72 is an information processing device configured to support linking between the metaverse A and the metaverse B and can also be called a relay server or a transfer server. FIG. 8 is a block diagram illustrating the main functional blocks of the conversion server 72. The conversion server 72 includes a data processing unit 74, a storage unit 76, and a communication unit 78. The data processing unit 74 executes various types of data processing related to metaverse linking. The storage unit 76 stores data to be referenced or updated by the data processing unit 74. The communication unit 78 communicates with external devices in accordance with a predetermined communication protocol. The data processing unit 74 sends and receives data to and from the metaverse A server 12 and the metaverse B server 16 via the communication unit 78.

The storage unit 76 stores correspondence relations between avatar operations in the metaverse A and avatar operations in the metaverse B. Specifically, the storage unit 76 stores correspondence relations between combinations of user operations and avatar actions in the metaverse A and combinations of user operations and avatar actions in the metaverse B. In other words, the storage unit 76 stores correspondence relations between key assignments related to controlling avatar actions in the metaverse A and key assignments related to controlling avatar actions in the metaverse B.

For example, it is assumed that, in the metaverse A, a o button operation is assigned to the avatar's jumping, a x button operation is assigned to the avatar's dashing movements, a 4 button operation is assigned to the avatar's hand-waving operation, and a button operation is assigned to the avatar's clapping. It is assumed that, in the metaverse B, the o button operation is assigned to the avatar's hand-waving operation, the x button operation is assigned to the avatar's clapping, the 4 button operation is assigned to the avatar's dashing movements, and the button operation is assigned to the avatar's jumping.

In this case, the storage unit 76 may store correspondence relations as follows.

The o button operation in the metaverse A corresponds to the button operation in the metaverse B.

The x button operation in the metaverse A corresponds to the 4 button operation in the metaverse B.

The A button operation in the metaverse A corresponds to the o button operation in the metaverse B.

The button operation in the metaverse A corresponds to the x button operation in the metaverse B.

The data processing unit 74 includes a participation request transfer unit 80, an MV image transfer unit 82, an avatar operation conversion unit 84, and an avatar operation transmission unit 86. The functions of the plurality of functional blocks may be implemented by a computer program. The above-mentioned computer program may be stored in a computer-readable non-transitory recording medium and installed into the storage of the conversion server 72 through that recording medium. Alternatively, the above-mentioned computer program may be downloaded via a communication network and installed into the storage of the conversion server 72. The processor (such as CPU) of the conversion server 72 may read out the above-mentioned computer program into the main memory and execute the computer program, thereby providing the functions of the above-mentioned plurality of functional blocks.

The participation request transfer unit 80 receives data requesting participation in the metaverse B by the metaverse A user (metaverse B temporary participating user), which has been transmitted from the metaverse A server 12, and transfers the data in question to the metaverse B server 16.

The MV image transfer unit 82 receives images of the metaverse B for the metaverse B temporary participating user (specifically, field of vision video for the simple avatar), which has been transmitted from the metaverse B server 16, and transfers the images in question to the metaverse A server 12.

The avatar operation conversion unit 84 receives information regarding operations input by the metaverse A user (metaverse B temporary participating user) on the simple avatar, which has been transmitted from the metaverse A server 12. This operation information is based on avatar operation rules defined in the metaverse A and includes types of button operations input by the metaverse A user (metaverse B temporary participating user) on the controller of the user terminal 14.

The avatar operation conversion unit 84 converts operation information based on the avatar operation rules defined in the metaverse A into operation information based on avatar operation rules defined in the metaverse B. Specifically, the avatar operation conversion unit 84 refers to the correspondence relations between key assignments stored in the storage unit 76 and identifies the type of button operation in the metaverse B associated with the type of button operation input on the controller. The avatar operation conversion unit 84 converts the type of button operation input on the controller indicated by the received operation information (for example, the o button operation) into a corresponding type of button operation in the metaverse B (for example, the button operation).

In a case where there is no type of button operation in the metaverse B associated with the type of button operation input on the controller indicated by the received operation information (for example, an L button or a R button operation), the avatar operation conversion unit 84 discards the received operation information.

The avatar operation transmission unit 86 transmits operation information, in which the type of button operation has been converted by the avatar operation conversion unit 84, to the metaverse B server 16.

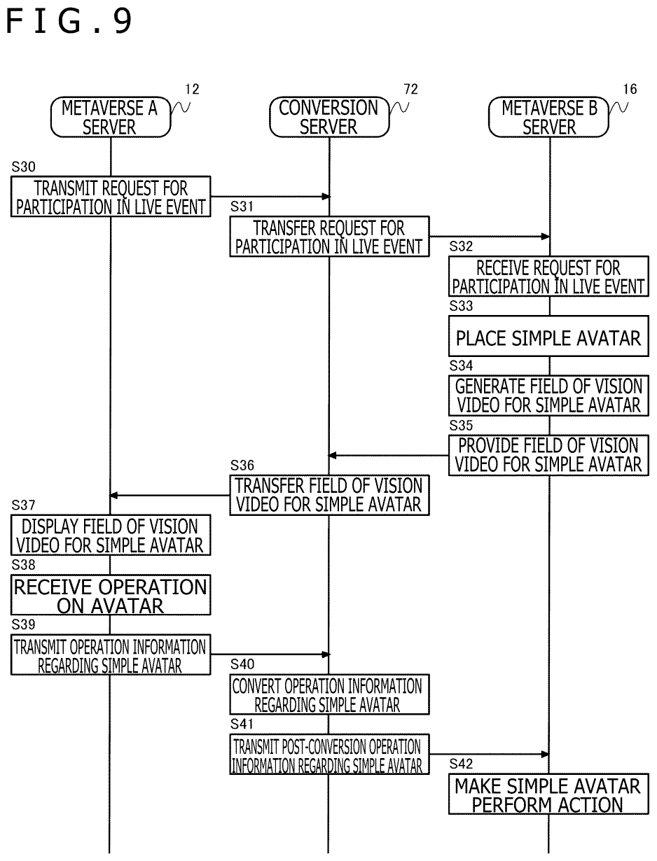

FIG. 9 illustrates the operation of the metaverse system 70 of the second embodiment. In FIG. 9, the illustration of the processing in S10 and S11 of FIG. 4 is omitted. The user terminal 14 transmits, in response to operations by the metaverse A user, a request for participation in a live event being held in the metaverse B to the metaverse A server 12. The participation request transmission unit 34 of the metaverse A server 12 transmits data requesting participation of the metaverse A user in question in the live event being held in the metaverse B to the conversion server 72 (S30). The participation request transfer unit 80 of the conversion server 72 receives the request from the metaverse A user for participation in the live event being held in the metaverse B, which has been transmitted from the metaverse A server 12, and transfers the request to the metaverse B server 16 (S31).

Since the processing in S32 to S34 in the metaverse B server 16 is the same as the processing in S13 to S15 of FIG. 4, the description thereof is omitted. The MV image provision unit 58 of the metaverse B server 16 transmits the field of vision video for the simple avatar generated in S34 to the conversion server 72 (S35). The MV image transfer unit 82 of the conversion server 72 receives the field of vision video for the simple avatar transmitted from the metaverse B server 16 and transfers the field of vision video to the metaverse A server 12 (S36). Since the processing in S37 and S38 in the metaverse A server 12 is the same as the processing in S17 and S18 of FIG. 4, the description thereof is omitted.

The avatar operation transmission unit 40 of the metaverse A server 12 transmits the information regarding an operation on the simple avatar, which has been received in S38, to the metaverse B server 16 (S39). The avatar operation conversion unit 84 of the conversion server 72 converts the type of button operation for an avatar action in the metaverse A, which is indicated by the operation information, into a corresponding type of button operation for an avatar action in the metaverse B (S40). The avatar operation transmission unit 86 of the conversion server 72 transmits the operation information after the conversion of the type of button operation to the metaverse B server 16 (S41). The avatar control unit 32 of the metaverse B server 16 makes the simple avatar of the metaverse B temporary participating user perform an action according to the operation information converted by the conversion server 72 (S42).

With the metaverse system 70 of the second embodiment, even in a case where there are differences in key assignments for avatar operations between the metaverse A and the metaverse B, such differences are absorbed by the conversion server 72. The metaverse A user temporarily participating in the metaverse B can make the simple avatar in the metaverse B perform actions as intended through the same operations as operations for the normal avatar in the metaverse A.

In the above, the present invention has been described on the basis of the second embodiment. This embodiment is illustrative, and it is to be understood by those skilled in the art that various modifications of combinations of each component and each processing process are possible, and that such modifications also fall within the scope of the present invention.

A first modified example related to the second embodiment is described. The storage unit 76 of the conversion server 72 may store data regarding a simple avatar (for example, data regarding the simple avatar for the metaverse A user temporarily participating in the metaverse B) defined in advance. When the participation request transfer unit 80 of the conversion server 72 transfers a request for temporal participation in the metaverse B, which has been received from the metaverse A server 12, to the metaverse B server 16, the participation request transfer unit 80 may also transmit the data regarding the simple avatar corresponding to the metaverse B temporary participating user to the metaverse B server 16.

Furthermore, the storage unit 76 may store simple avatars with different appearances for respective metaverses (for example, the metaverse A, the metaverse C, and the metaverse D) to which users temporarily participating in the metaverse B belong. When the participation request transfer unit 80 of the conversion server 72 transfers a request for participation in the metaverse B to the metaverse B server 16, the participation request transfer unit 80 may also transmit data regarding a simple avatar corresponding to the metaverse to which the user temporarily participating in the metaverse B belongs to the metaverse B server 16.

A second modified example related to the second embodiment is described. The user terminal 14 (for example, a controller) of the metaverse A user temporarily participating in the metaverse B may directly transmit information regarding operations on the simple avatar (for example, information regarding operated buttons) to the conversion server 72 without intermediation of the metaverse A server 12.

A third modified example related to the second embodiment is described. The conversion server 72 may link three or more metaverses (for example, the metaverse A, the metaverse B, and the metaverse C) by relaying communication between three or more metaverse management devices.

Any combination of the embodiments and modified examples described above is also useful as an embodiment of the present invention. A new embodiment resulting from combinations has the effects of each combined embodiment and modified example. Furthermore, it is also to be understood by those skilled in the art that the functions that the respective constituent elements described in claims are to fulfill may be achieved by a corresponding one of the components described in the embodiments and the modified examples alone, or through cooperation therebetween.

The technical ideas described in the above-mentioned embodiments and modified examples can be expressed as aspects described in the following respective items.

### Item 1

An information processing system including:
a first device configured to provide an image of a first metaverse to a first user utilizing the first metaverse; and
a second device configured to provide an image of a second metaverse to a second user utilizing the second metaverse, in which,
in a case where the second device receives a request for participation in the second metaverse by the first user, which has been transmitted from the first device, the second device places a simplified avatar corresponding to the first user in the second metaverse and provides the image of the second metaverse to the first user.

With this information processing system, it is possible to provide images of the second metaverse to the first user utilizing the first metaverse, thereby providing a high degree of interest to the user through linking of a plurality of metaverses. Furthermore, the avatar corresponding to the first user is placed in the second metaverse, thereby enabling the first user to have a strong sense of participation in the second metaverse. Furthermore, with the avatar corresponding to the first user being configured as a simplified avatar, it is possible to reduce the processing load on the second device configured to provide the second metaverse, thereby avoiding, for example, the shortage of hardware resources of the second device.

### Item 2

The information processing system according to Item 1, in which the simplified avatar corresponding to the first user contains a smaller amount of information than an avatar corresponding to the first user set in the first metaverse.

With this information processing system, it is possible to reduce the processing load on the second device configured to provide the second metaverse.

### Item 3

The information processing system according to Item 1 or 2, in which
the second device makes, in response to an operation input by the first user on the simplified avatar, the simplified avatar corresponding to the first user perform an action within the second metaverse.

With this information processing system, it is possible to enable the first user to have a stronger sense of participation in the second metaverse, thereby providing a high degree of interest to the first user.

### Item 4

The information processing system according to Item 3, in which the action of the simplified avatar corresponding to the first user within the second metaverse is restricted to a simplified action defined in advance.

With this information processing system, it is possible to reduce the processing load on the second device configured to provide the second metaverse.

### Item 5

The information processing system according to any one of Items 1 to 4, in which
the second device provides an image of the second metaverse as viewed from a perspective of the simplified avatar corresponding to the first user to the first user.

With this information processing system, it is possible to enable the first user to have a stronger sense of participation in the second metaverse, thereby providing a high degree of interest to the first user.

### Item 6

The information processing system according to any one of Items 1 to 5, in which
the second device displays the simplified avatar corresponding to the first user in the second metaverse in a mode indicating that the simplified avatar corresponds to a user of the first metaverse.

With this information processing system, it is presented to users of the second metaverse that users of the first metaverse are participating in the second metaverse. With this, it is possible to elicit reactions or behaviors from the users of the second metaverse toward the participation of the users of the first metaverse in the second metaverse.

### Item 7

The information processing system according to any one of Items 1 to 6, in which
the first device hides an avatar corresponding to the first user in the first metaverse while the first user is participating in the second metaverse.

With this information processing system, it is possible to prevent, while the first user is participating in the second metaverse, the avatar corresponding to the first user in the first metaverse from performing actions not intended by the user in question. Furthermore, it is possible to prevent other users from misunderstanding that the first user is currently participating in the first metaverse.

### Item 8

The information processing system according to any one of Items 1 to 6, in which
the first device makes, while the first user is participating in the second metaverse, an avatar corresponding to the first user in the first metaverse perform the same action as the simplified avatar corresponding to the first user in the second metaverse.

With this information processing system, it is possible to present actions of the simplified avatar corresponding to the first user in the second metaverse to other users of the first metaverse, thereby enhancing the interest through linking of a plurality of metaverses.

### Item 9

The information processing system according to any one of Items 1 to 6 or Item 8, in which
the first device displays, while the first user is participating in the second metaverse, an avatar corresponding to the first user in the first metaverse in a mode indicating that the first user is currently participating in the second metaverse.

With this information processing system, it is possible to prevent other users from misunderstanding that the first user is currently participating in the first metaverse. Furthermore, it is possible to provide motivation to participate in the second metaverse to other users of the first metaverse, thereby promoting linking between metaverses.

### Item 10

The information processing system according to any one of Items 1 to 9, further including:
a conversion device configured to retain a correspondence relation between an avatar operation in the first metaverse and an avatar operation in the second metaverse, in which the conversion device is configured to receive an operation that includes an operation input by the first user on the simplified avatar and an avatar operation in the first metaverse, and
transmit information indicating an avatar operation in the second metaverse corresponding to the avatar operation in the first metaverse to the second device.

With this information processing system, differences in the method of operating avatars between the first metaverse and the second metaverse can be absorbed by the conversion device, thereby making the simplified avatar corresponding to the first user in the second metaverse perform actions as intended by the first user.

### Item 11

An information processing device which is a device configured to provide, to a user of a predetermined metaverse, an image of the metaverse, the information processing device including:
a reception unit configured to receive a request for participation in the predetermined metaverse by a user of a different metaverse from the predetermined metaverse;
a placement unit configured to place, in the predetermined metaverse, a simplified avatar corresponding to the user of the different metaverse; and
a provision unit configured to provide the image of the predetermined metaverse to the user of the different metaverse. Here, the metaverse provided by the information processing device is referred to as the second metaverse, and a metaverse different from the second metaverse is referred to as the first metaverse. Furthermore, a user of the first metaverse is referred to as the first user, and a user of the second metaverse is referred to as the second user. With this information processing device, it is possible to provide images of the second metaverse to the first user, thereby providing a high degree of interest to the user through linking of a plurality of metaverses. Furthermore, the avatar corresponding to the first user is placed in the second metaverse, thereby enabling the first user to have a strong sense of participation in the second metaverse. Furthermore, with the avatar corresponding to the first user being configured as a simplified avatar, it is possible to reduce the processing load on the information processing device in question configured to provide the second metaverse, thereby avoiding, for example, the shortage of hardware resources of the information processing device in question.

### Item 12

A conversion device configured to communicate with a first device configured to provide an image of a first metaverse to a first user utilizing the first metaverse, and with a second device configured to provide an image of a second metaverse to a second user utilizing the second metaverse, in which,
in a case where the second device receives a request for participation in the second metaverse by the first user, which has been transmitted from the first device, the second device places a simplified avatar corresponding to the first user in the second metaverse and provides the image of the second metaverse to the first user, and
the conversion device includes
a retention unit configured to retain a correspondence relation between an avatar operation in the first metaverse and an avatar operation in the second metaverse, and
a conversion unit configured to receive an operation that includes an operation input by the first user on the simplified avatar and an avatar operation in the first metaverse, and to transmit information indicating an avatar operation in the second metaverse corresponding to the avatar operation in the first metaverse to the second device.

With the avatar corresponding to the first user in the second metaverse being configured as a simplified avatar, it is possible to reduce the processing load on the second device configured to provide the second metaverse. Moreover, differences in the method of operating avatars between the first metaverse and the second metaverse can be absorbed by the conversion device, thereby making the simplified avatar corresponding to the first user in the second metaverse perform actions as intended by the first user.

### Item 13

An information processing method including:
by a computer configured to provide, to a user of a predetermined metaverse, an image of the metaverse,
a step of receiving a request for participation in the predetermined metaverse by a user of a different metaverse from the predetermined metaverse;
a step of placing, in the predetermined metaverse, a simplified avatar corresponding to the user of the different metaverse; and
a step of providing the image of the predetermined metaverse to the user of the different metaverse.

With this information processing method, the above-mentioned computer exhibits effects similar to those of the information processing device of Item 11.

### Item 14

A computer program for causing a computer configured to provide, to a user of a predetermined metaverse, an image of the metaverse, to achieve:
a function of receiving a request for participation in the predetermined metaverse by a user of a different metaverse from the predetermined metaverse;
a function of placing, in the predetermined metaverse, a simplified avatar corresponding to the user of the different metaverse; and
a function of providing the image of the predetermined metaverse to the user of the different metaverse.

With this computer program, it is possible to achieve the computer configured to exhibit effects similar to those of the information processing device of Item 11.

### Industrial Applicability

The technology of the present disclosure can be applied to information processing systems, information processing devices, and the like.

### REFERENCE SIGNS LIST

10: Metaverse system
12: Metaverse A server
16: Metaverse B server
56: MV image generation unit
58: MV image provision unit
60: Avatar generation unit
62: Avatar control unit
64: Participation request reception unit
66: Avatar operation reception unit
72: Conversion server
84: Avatar operation conversion unit
86: Avatar operation transmission unit

1. An information processing system comprising:
a first device configured to provide an image of a first metaverse to a first user utilizing the first metaverse; and
a second device configured to provide an image of a second metaverse to a second user utilizing the second metaverse, wherein,
in a case where the second device receives a request for participation in the second metaverse by the first user, which has been transmitted from the first device, the second device places a simplified avatar corresponding to the first user in the second metaverse and provides the image of the second metaverse to the first user.

2. The information processing system according to claim 1, wherein
the simplified avatar corresponding to the first user contains a smaller amount of information than an avatar corresponding to the first user set in the first metaverse.

3. The information processing system according to claim 1, wherein
the second device makes, in response to an operation input by the first user on the simplified avatar, the simplified avatar corresponding to the first user perform an action within the second metaverse.

4. The information processing system according to claim 3, wherein
the action of the simplified avatar corresponding to the first user within the second metaverse is restricted to a simplified action defined in advance.

5. The information processing system according to claim 1, wherein
the second device provides an image of the second metaverse as viewed from a perspective of the simplified avatar corresponding to the first user to the first user.

6. The information processing system according to claim 1, wherein
the second device displays the simplified avatar corresponding to the first user in the second metaverse in a mode indicating that the simplified avatar corresponds to a user of the first metaverse.

7. The information processing system according to claim 1, wherein
the first device hides an avatar corresponding to the first user in the first metaverse while the first user is participating in the second metaverse.

8. The information processing system according to claim 1, wherein
the first device makes, while the first user is participating in the second metaverse, an avatar corresponding to the first user in the first metaverse perform a same action as the simplified avatar corresponding to the first user in the second metaverse.

9. The information processing system according to claim 1, wherein
the first device displays, while the first user is participating in the second metaverse, an avatar corresponding to the first user in the first metaverse in a mode indicating that the first user is currently participating in the second metaverse.

10. The information processing system according to claim 1, further comprising:
a conversion device configured to retain a correspondence relation between an avatar operation in the first metaverse and an avatar operation in the second metaverse, wherein
the conversion device is configured to
receive an operation that includes an operation input by the first user on the simplified avatar and an avatar operation in the first metaverse, and
transmit information indicating an avatar operation in the second metaverse corresponding to the avatar operation in the first metaverse to the second device.

11. An information processing device which is a device configured to provide, to a user of a predetermined metaverse, an image of the metaverse, the information processing device comprising:
a reception unit configured to receive a request for participation in the predetermined metaverse by a user of a different metaverse from the predetermined metaverse;
a placement unit configured to place, in the predetermined metaverse, a simplified avatar corresponding to the user of the different metaverse; and
a provision unit configured to provide the image of the predetermined metaverse to the user of the different metaverse.

12. A conversion device configured to communicate with a first device configured to provide an image of a first metaverse to a first user utilizing the first metaverse, and with a second device configured to provide an image of a second metaverse to a second user utilizing the second metaverse, wherein,
in a case where the second device receives a request for participation in the second metaverse by the first user, which has been transmitted from the first device, the second device places a simplified avatar corresponding to the first user in the second metaverse and provides the image of the second metaverse to the first user, and
the conversion device includes
a retention unit configured to retain a correspondence relation between an avatar operation in the first metaverse and an avatar operation in the second metaverse, and
a conversion unit configured to receive an operation that includes an operation input by the first user on the simplified avatar and an avatar operation in the first metaverse, and to transmit information indicating an avatar operation in the second metaverse corresponding to the avatar operation in the first metaverse to the second device.

13. An information processing method, comprising:
by a computer configured to provide, to a user of a predetermined metaverse, an image of the metaverse,
receiving a request for participation in the predetermined metaverse by a user of a different metaverse from the predetermined metaverse;
placing, in the predetermined metaverse, a simplified avatar corresponding to the user of the different metaverse; and
providing the image of the predetermined metaverse to the user of the different metaverse.

14. A computer program for a computer configured to provide, to a user of a predetermined metaverse, an image of the metaverse, comprising:
by a reception unit, receiving a request for participation in the predetermined metaverse by a user of a different metaverse from the predetermined metaverse;
by a placement unit, placing, in the predetermined metaverse, a simplified avatar corresponding to the user of the different metaverse; and
by a provision unit, providing the image of the predetermined metaverse to the user of the different metaverse.
